(19) United States
(12) Patent Application Publication
(10) Pub. No.: US 2026/0132918 A1
(43) Pub. Date: May 14, 2026

(54) Lamp post, lamp, method for watering plants and use

(71) Applicant: WE-EF LEUCHTEN GmbH, Bispingen (DE)

(72) Inventors: Julian Marcel Gawrisch, Bangkok (TH); John Hart, Samutprakarn (TH); Thanin Pruttiporn-Weerakul, Samutprakarn (TH)

(21) Appl. No.: 19/116,279

(22) PCT Filed: Sep. 27, 2023
(86) PCT No.: PCT/DE2023/000117

§ 371 Date: Mar. 27, 2025

(30) Foreign Application Priority Data
Sep. 28, 2022 (DE) 10 2022 003 596.0

(51) Int. Cl. F21V 33/00; A01G 9/02; A01G 9/24; A01G 27/02; F21S 8/08; F21V 21/02

(52) U.S. Cl. CPC F21V 33/006; A01G 9/023; A01G 9/249; A01G 27/02; F21S 8/086; F21V 21/02

(57) ABSTRACT

A lamp post is disclosed, comprising an elongated base body, characterized in that the elongated base body is configured in such a way that watering is provided for plants arranged on the base body.

The invention relates to a lamp post, a lamp, a method for watering plants and a use.

A wide variety of lamps are known from the prior art, which have very different structures and fulfill a wide range of tasks, particularly with regard to technical or aesthetic aspects of light. Other aspects outside of these two areas are generally not taken into account.

The purpose of the present invention is therefore to provide a lamp post and a lamp in which further aspects outside the two areas listed above are realized.

This problem is solved by the invention of a lamp post according to claim 1, a lamp according to claim 13, a method according to claim 14 and a use according to claim 15.

The lamp post according to the invention is one with an elongated base body, wherein the elongated base body is designed in such a way that watering is provided for plants arranged on the base body, for example and in particular as shown in the claims and this description.

In this context, it is advantageous, as proven, if the lamp post is designed in such a way that the base body has at least one tube- and/or hose-like channel in which water and/or a liquid nutrient medium can be transported inside the base body/is transported in use.

In this context, it is advantageous, since it has been proven, if the upper area of the base body has a water distribution element, for example and in particular a perforated plate, for at least partial radial distribution of water and/or nutrient medium, in order to provide irrigation that is as radially uniform as possible.

Furthermore, it is advantageous, as proven, if the base body has at least one water connection, for example and in particular realized as a hose connection, for example and in particular designed as an olive.

In addition, it is advantageous, as proven, if the base body has a nutrient reservoir inside, for example and in particular designed as coconut fibers.

Furthermore, it is advantageous, as proven, if the base body has on its outer side at least one material recess, for example and in particular in the form of a hole, but usually several and usually radially distributed material recesses, for example and in particular in the form of holes, for receiving plants.

Furthermore, it is advantageous, as proven, if a radial interspace is realized in the interior of the base body, in which the nutrient medium is introduced, in order to provide a radially uniform supply of nutrients in this way.

It is particularly advantageous, as proven, if the lamp post is designed in such a way that a connected hose introduces water into the at least one tube- and/or hose-like channel of the base body via the hose connection, whereby the water in the channel inside the base body is transported upwards into the upper area of the base body, then distributed radially by means of a perforated plate-shaped water distribution element and poured over the nutrient medium, so that the water flows from top to bottom through the nutrient medium, which is located in the radial interspace, and in doing so waters the plants, which are accommodated by means of the at least one material recess on the outside of the base body and are thus arranged on the base body.

Furthermore, a lamp is claimed, which has a lamp post according to the invention, a method for watering plants, wherein a lamp post or a lamp according to the invention is used, and a use of a lamp post or a lamp according to the invention for watering plants arranged on the base body, shown in this disclosure, of the lamp post.

The invention is explained in the following embodiments only by way of example and in a non-limiting manner, wherein:

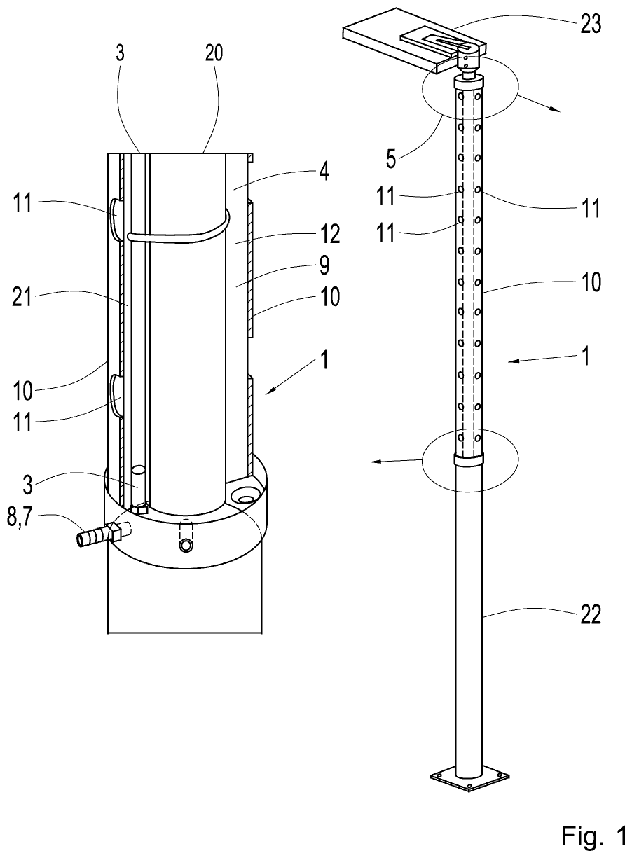

FIG. 1 is a sketchy and perspective representation of a lamp according to the invention with a corresponding enlarged section of a central section;

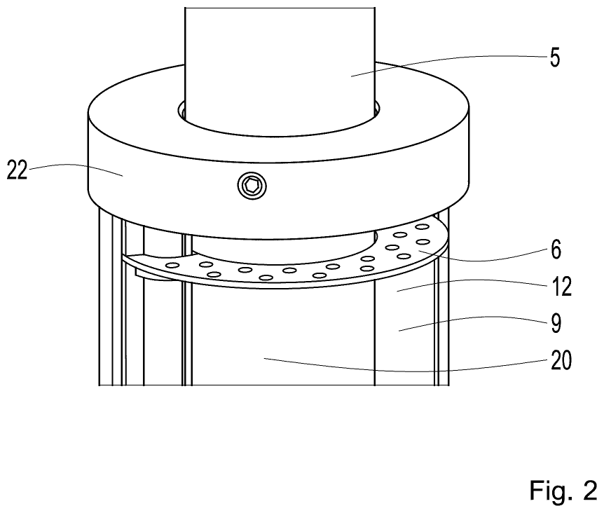

FIG. 2—a sketch-like and perspective representation of a section enlargement of an upper section of the lamp shown in FIG. 1;

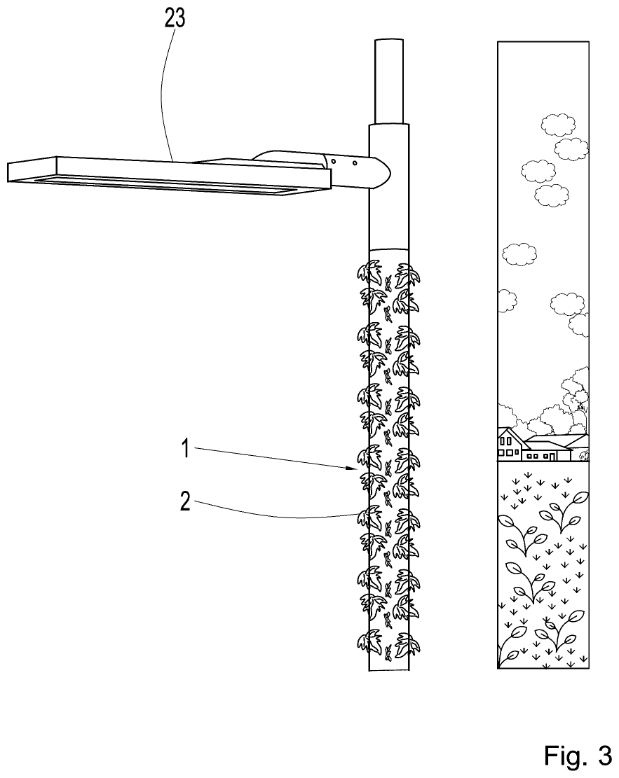

FIG. 3—a sketch-like and perspective representation of a middle to upper section of the lamp shown in FIG. 1 in the planted state.

The three figures show an embodiment of a lamp post and a lamp according to the invention. The lamp post, with an elongated base body 1, is characterized in that the elongated base body 1 is designed in such a way that watering is provided for plants (2) arranged on the base body 1.

The base body 1 has at least one pipe- and/or hose-like channel 3, in which water and/or a liquid nutrient medium can be transported in the interior 4 of the base body 1/is transported in use.

The lamp post has a water distribution element 6 in the upper area 5 of the base body 1 for at least partial radial distribution of water and/or nutrient medium.

The water distribution element 6 is a perforated plate.

The base body 1 has at least one water connection 7.

The water connection 7 is designed as a hose connection 8.

The hose connector 8 is designed as an olive.

The base body 1 has a nutrient reservoir 9 inside 4.

The nutrient reservoir 9 is designed as coconut fibers, for example and in particular in the form of mats.

The base body 1 has on its outer side 10 at least one material recess 11 for receiving plants 2; here there are several radially distributed material recesses 11.

In the interior 4 of the base body 1 there is a radial intermediate space 12 in which the nutrient medium is introduced.

The lamp post is designed in such a way that a connected hose introduces water into the at least one tube- and/or hose-like channel 3 of the base body 1 via the hose connection 8, whereby the water in the channel 3 inside 4 of the base body 1 is transported upwards into the upper area 5 of the base body 1, then distributed radially by a perforated plate-shaped water distribution element 6 and poured over the nutrient medium, so that the water flows from top to bottom through the nutrient medium, which is located in the radial interspace 12, and in so doing water the plants 2, which are held by means of the at least one material recess 11 on the outside 10 of the base body 1 and are thus arranged on the base body 1.

The radial interspace 12 is essentially formed between an inner tubular element 20 of the base body 1 and the outer side 10 of the base body 1. The lamp post according to the invention is connected at the upper area 5 to a lamp body 23, optionally via a—not shown—first adapter and at the middle area to a base pole 22, optionally via a second adapter (not shown). The lamp post can have an air bubble line (21) between the nutrient medium and the outer side (10) to ensure better pressure equalization for better water flow.

1. Lamp post having an elongated base body, wherein the elongated base body is designed in such a way that watering is provided for plants arranged on the base body.

2. Lamp post according to claim 1, wherein it is designed in such a way that the base body has at least one tube- and/or hose-like channel in which water and/or a liquid nutrient medium can be transported in the interior of the base body/is transported in use.

3. Lamp post according to claim 2, wherein a water distribution element for at least partial radial distribution of water and/or nutrient medium is provided in the upper region of the base body.

4. Lamp post according to claim 3, wherein the water distribution element is a perforated plate.

5. Lamp post according to claim 1, wherein the base body has at least one water connection.

6. Lamp post according to claim 5, wherein the water connection is designed as a hose connection.

7. Lamp post according to claim 6, wherein the hose connection is designed as a nipple.

8. Lamp post according to claim 1, wherein the base body has a nutrient reservoir in the interior.

9. Lamp post according to claim 8, wherein the nutrient reservoir is designed as coconut fibres.

10. Lamp post according to claim 1, wherein the outer side of the base body has at least one material recess for receiving plants.

11. Lamp post according to claim 8, wherein a radial interspace, in which the nutrient medium is introduced, is realized in the interior of the base body.

12. Lamp post according claim 1, wherein it is designed in such a way that a connected hose introduces water into the at least one pipe- and/or hose-like channel of the base body via the hose connection, whereby the water in the channel in the interior of the base body is transported upwards into the upper area of the base body in order to then be distributed radially by means of a perforated plate-shaped water distribution element and poured over the nutrient medium, so that the water flows from top to bottom through the nutrient medium, which is located in the radial interspace, and in so doing watering the plants received by means of the at least one material recess on the outside of the base body and thus arranged on the base body.

13. A lamp comprising a lamp post according to claim 1.

14. A method for watering plants, wherein a lamp post according claim 1 is used.

15. Use of a lamp post according to claim 1 for watering plants arranged on the base body.
